(19) United States
(12) Patent Application Publication
(10) Pub. No.: US 2025/0063328 A1
(43) Pub. Date: Feb. 20, 2025

(54) METHOD AND APPARATUS FOR SUPPORTING INTEGRATED SENSING SERVICE IN COMMUNICATION SYSTEM

(71) Applicant: Samsung Electronics Co., Ltd., Suwon-si (KR)

(72) Inventors: Dongeun SUH, Suwon-si (KR); Hyesung KIM, Suwon-si (KR); Sangjun MOON, Suwon-si (KR); Hoyeon LEE, Suwon-si (KR)

(21) Appl. No.: 18/808,571

(22) Filed: Aug. 19, 2024

(30) Foreign Application Priority Data
Aug. 18, 2023 (KR) 10-2023-0108024

(51) Int. Cl. H04W 4/38; H04W 4/029; H04W 64/00

(52) U.S. Cl. CPC H04W 4/38; H04W 4/029; H04W 64/00

(57) ABSTRACT

The disclosure relates to a 5G or 6G communication system for supporting a higher data transmission rate. A method for providing an integrated sensing service in a wireless communication system is provided. The method includes receiving, from a first device, a request message for requesting a sensing service related to at least one sensing node, transmitting, to an access and mobility management function (AMF) related to the at least one sensing node, a transfer request message for requesting sensing service activation based on the request message, and receiving, from the at least one sensing node, at least one sensing event notification message including a sensing result based on the request message.

### CROSS-REFERENCE TO RELATED APPLICATION(S)

This application is based on and claims priority under 35 U.S.C. § 119 (a) of a Korean patent application number 10-2023-0108024, filed on Aug. 18, 2023, in the Korean Intellectual Property Office, the disclosure of which is incorporated by reference herein in its entirety.

### BACKGROUND

### 1. Field

The disclosure relates to a method and an apparatus for providing an integrated sensing service in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHZ and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, as aspect of the disclosure is to provide various sensing services by utilizing an entity (e.g., a base station and a UE) capable of communication in a mobile communication system.

Another aspect of the disclosure is to provide an integrated sensing and communications technology in a mobile communication system.

Another aspect of the disclosure is to provide a service provider to provide a sensing service through a UE/base station/cell in a mobile communication network.

Another aspect of the disclosure is to provide a sensing service structure and a sensing service providing method considering scalability to relieve the effect of sensing information traffic on the quality of an existing communication service.

Another aspect of the disclosure is to provide a method and an apparatus for providing a sensing service considering scalability in a mobile communication network.

In accordance with an aspect of the disclosure, a method for providing an integrated sensing service by a network entity in a wireless communication system is provided. The method includes receiving, from a first device, a request message for requesting a sensing service related to at least one sensing node, transmitting, to an access and mobility management function (AMF) related to the at least one sensing node, a transfer request message for requesting sensing service activation based on the request message, and receiving, from the at least one sensing node, at least one sensing event notification message including a sensing result based on the request message.

In accordance with another aspect of the disclosure, a network entity for providing an integrated sensing service in a wireless communication system is provided. The network entity includes a transceiver and a processor operatively coupled to the transceiver, wherein the processor is configured to receive, from a first device, a request message for requesting a sensing service related to at least one sensing node, transmit, to an access and mobility management function (AMF) related to the at least one sensing node, a transfer request message for requesting sensing service activation based on the request message, and receive, from the at least one sensing node, at least one sensing notification message including a sensing result based on the request message.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration example of a wireless communication system according to an embodiment of the disclosure;

FIG. 2 is a sequence diagram illustrating a sensing provider function (SPF) registration procedure through a network repository function (NRF) according to an embodiment of the disclosure;

FIG. 3 is a sequence diagram illustrating an SPF discovery procedure through an NRF according to an embodiment of the disclosure;

FIG. 4 is a sequence diagram illustrating a procedure in which an AF triggers activation of a sensing service according to an embodiment of the disclosure;

FIG. 5 is a sequence diagram illustrating a procedure in which a UE triggers activation of a sensing service according to an embodiment of the disclosure;

FIG. 6 is a sequence diagram illustrating a procedure in which a UE triggers activation of a sensing service through a user plane according to an embodiment of the disclosure;

FIG. 7 is a block diagram illustrating the configuration of a UE according to an embodiment of the disclosure; and

FIG. 8 is a block diagram illustrating the configuration of a network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing a communication function. Furthermore, the embodiments of the disclosure as described below may also be applied to other communication systems having similar technical backgrounds or channel types to the embodiments of the disclosure. In addition, based on determinations by those skilled in the art, the embodiments of the disclosure may be applied to other communication systems through some modifications without significantly departing from the scope of the disclosure.

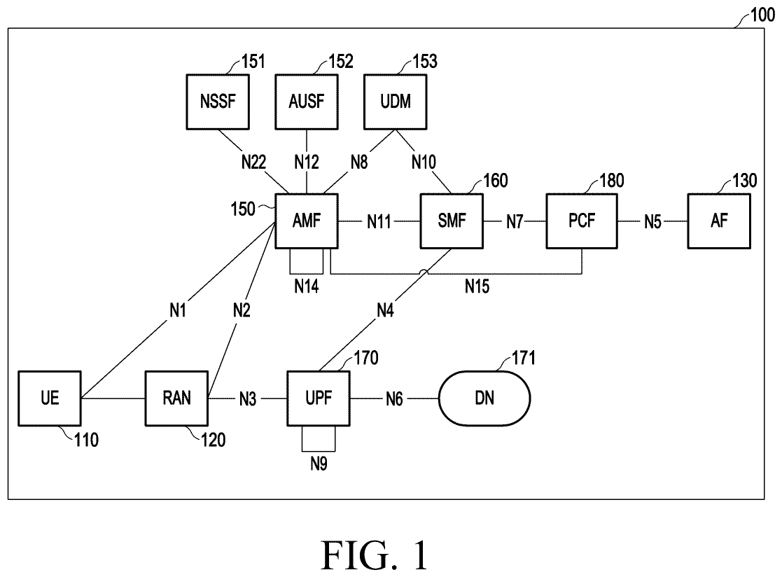

In the disclosure, a network technology may be referenced in standards (e.g., TS 23.501, TS 23.502, and TS 23.503) defined by the International Telecommunication Union (ITU) or the third generation partnership project (3GPP), and components included in a network structure of FIG. 1 may respectively refer to physical entities, software that performs separate functions, or hardware combined with the software. In the drawings, reference symbols shown as Nx, such as N1, N2, and N3, indicate known interfaces between NFs in a 5G core network (CN), and a relevant description may be referenced in a standard (TS 23.501), and thus a detailed description will be omitted.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, some of terms and names defined in the 3rd generation partnership project long term evolution (3GPP LTE) standards may be used for the sake of descriptive convenience. However, the disclosure is not limited by these terms and names, and may be applied in the same way to systems that conform other standards.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 is a block diagram illustrating a configuration example of a wireless communication system according to an embodiment of the disclosure. In the illustrated example, the wireless communication system may include a 5G mobile communication network 100.

Referring to FIG. 1, the 5G mobile communication network 100 may include a 5G user equipment (UE) 110, a radio access network (RAN) 120 (e.g., at least one of a base station, a 5g nodeB (gNB), or an evolved nodeB (eNB)), and a 5G core network. The 5G core network may include at least one of an access and mobility management function (AMF) 150 configured to provide a mobility management function of the UE 110, a session management function (SMF) 160 configured to provide a session management function, a user plane function (UPF) 170 responsible for forwarding data to a data network (DN) 171, a policy control function (PCF) 180 configured to provide a policy control function, a network slicing selection function (NSSF) 151, an authentication server function (AUSF) 152, a unified data management (UDM) 153 configured to provide a function of managing data, such as subscriber data and policy control data, or an application function (AF) 130. Although not shown, the 5G core network may further include network functions, such as a unified data repository (UDR) configured to store data on various network functions (NFs), a network repository function (NRF), a network exposure function (NEF), or a network data analytics function (NWDAF).

In a 3GPP system, a conceptual link connecting NFs in a 5G system is defined as a reference point. Reference points included in a 5G system architecture shown in FIG. 1 are illustrated below.
N1: Reference point between UE 110 and AMF 150
N2: Reference point between (R)AN 120 and AMF 150
N3: Reference point between (R)AN 120 and UPF 170
N4: Reference point between SMF 160 and UPF 170
N5: Reference point between PCF 180 and AF 130
N6: Reference point between UPF 170 and DN 171
N7: Reference point between SMF 160 and PCF 180
N8: Reference point between UDM 153 and AMF 150
N9: Reference point between two core UPFs (e.g., reference point between UPFs 170)
N10: Reference point between UDM 153 and SMF 160
N11: Reference point between AMF 150 and SMF 160
N12: Reference point between AMF 150 and AUSF 152
N13: Reference point between UDM and AUSF 152
N14: Reference point between two AMFs (e.g., reference point between AMFs 150)
N15: Reference point between PCF 180 and AMF 150 in non-roaming scenario; reference point between PCF 180 and AMF 150 within visited network in roaming scenario

The 5G core network may further include an NF (e.g. a sensing provider function (SPF)) configured to manage a sensing service using a UE/base station that provides an integrated sensing and communications (ISAC) function, such as object detection and/or map generation, based on a wireless signal transmitted/received for communication. The SPF may provide functions of storing a request for a sensing function based on an entity (e.g., the RAN 120 and/or the UE 110) supporting ISAC, performing signaling with an entity (e.g., the RAN 120 and/or the UE 110) configured to perform a sensing function for sensing activation and deactivation required based on the request, and collecting sensing information from the entity (e.g., the RAN 120 and/or the UE 110) configured to perform the sensing function and processing/forwarding the collected information. The NF providing these functions may be referred to as a different term other than the SPF.

The SPF may be located as a separate NF, or may be collocated with at least one of the NEF, the PCF 180, or the NWDAF.

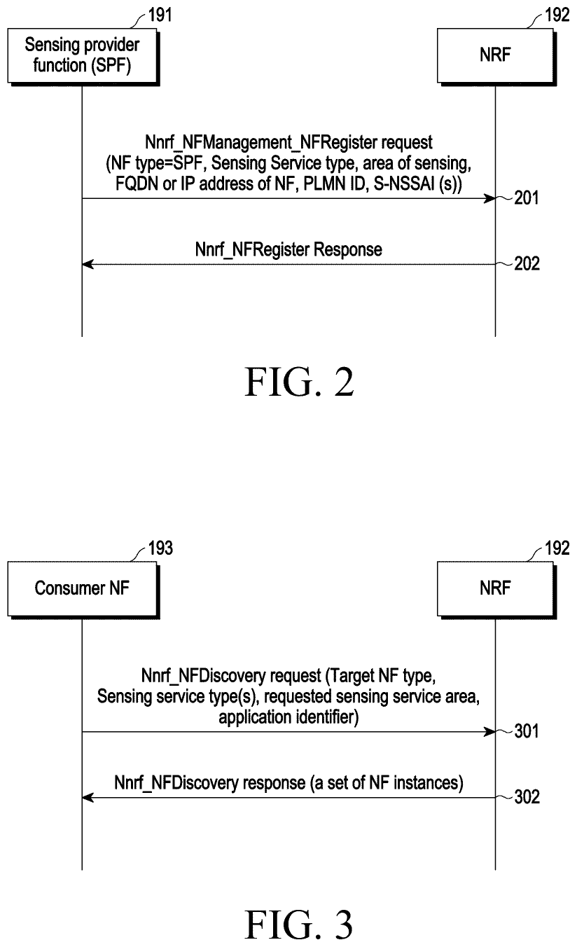

FIG. 2 is a sequence diagram illustrating an SPF registration procedure through an NRF according to an embodiment of the disclosure. At least one of the following operations may be omitted, modified, or performed in a different order depending on embodiments.

Referring to FIG. 2, in operation 201, an SPF 191 may transmit a registration request message (e.g., a Nnrf_NFManagmenet_NFRegister request) to an NRF 192 when an NF profile of the SPF 191 is changed or the NF profile has not yet been registered with the NRF 192. In an embodiment, the message may include at least one of the following information elements.
NF type: Information indicating the SPF 191 may be included.
Sensing service type: One or more of pieces of information indicating the type(s) of a sensing service supported by the SPF 191 may be included. For example, at least one of spatial mapping, 3-dimensional (3D) map generation, intruder detection, object detection, or ranging may be included.
Area of sensing: Information about an area in which the SPF 191 supports the sensing function may be included. For example, at least one of a list of timing advance (TA(s)), a list of cell(s), or a geographical area may be included.
Fully qualified domain name (FQDN) or internet protocol (IP) address of NF: The address (e.g., FQDN or IP address) of the SPF 191 may be included.
Public land mobile network (PLMN) ID: The ID(s) of a PLMN which the SPF 191 belongs to (or supports) may be included.
Single network slice selection assistance information (S-NSSAI(s)): The identifier(s) of a network slice supported by SPF may be included.

The NRF 192 may register/store information included in the registration request message of operation 201. When registration succeeds, the NRF 192 may transmit a registration response message (e.g., a Nnrf_NFRegister response) including information indicating the successful registration to the SPF 191 in operation 202.

FIG. 3 is a sequence diagram illustrating an SPF discovery procedure through an NRF according to an embodiment of the disclosure. At least one of the following operations may be omitted, modified, or performed in a different order according to embodiments.

Referring to FIG. 3, in operation 301, a consumer NF 193 (e.g., at least one of an NEF 194, an SMF 160, an AMF 150, or an AF 130), which is an NF that requires a sensing service, may transmit a discovery request message (e.g., a Nnrf_NFDiscovery request) to an NRF 192 to obtain information about an SPF 191. In an embodiment, the message may include at least one of the following information elements.
Target NF type: An NF type indicating the SPF may be included.
Sensing service type(s): When the target NF type is the SPF, information indicating the type(s) of a sensing service requested by the consumer NF 193 may be included.
Requested sensing service area: When the target NF type is the SPF, information about an area in which the sensing service is to be used may be included.
PLMN ID: A requested PLMN ID may be included.

The NRF 192 may determine information about NFs to be included in a response message among previously registered NFs, based on information included in the discovery request message of operation 301.

When the target NF type included in the discovery request message indicates the SPF (e.g., the SPF 191), the NRF may include the information about the SPF 191 (e.g., an NF instance ID, an IP address(es), and/or a FQDN) in a response message (e.g., a Nnrf_NFDiscovery response) in operation 302. When the NF profiles of a plurality of SPFs are stored in the NRF 192, the discovery response message may include at least one of the NF instance ID, the IP address(es), or the FQDN of each SPF.

When the discovery request message of operation 301 includes the sensing service type(s), the NRF 192 may include at least one of the NF instance ID, the IP address(es), or the FQDN of each SPF of an SPF(s) supporting the sensing service type(s) in the discovery response message.

When the discovery request message of operation 301 includes the requested sensing service area, at least one of the NF instance ID, the IP address(es), or the FQDN of each SPF of an SPF(s) supporting the requested sensing service area may be included in the discovery response message.

The consumer NF 193 may select the SPF 191 through SPF selection, based on the information about SPF instances (e.g., at least one of the NF instance ID, the IP address(es), or the FQDN) received in operation 302, and may transmit a message for the sensing service (not shown) to the selected SPF 191.

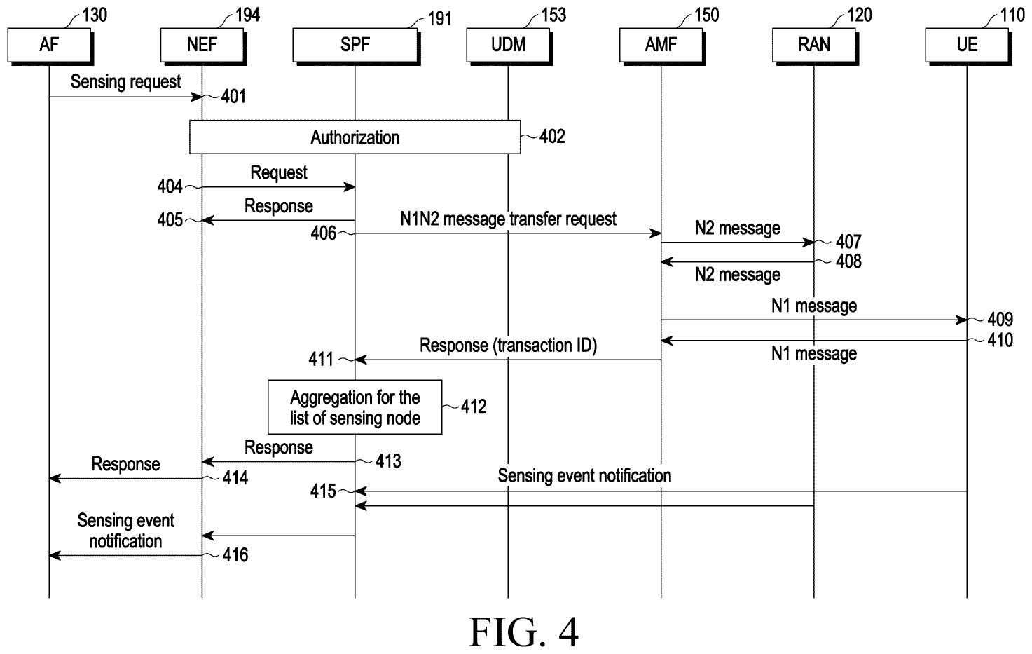

FIG. 4 is a sequence diagram illustrating a procedure in which an AF triggers activation of a sensing service according to an embodiment of the disclosure. At least one of the following operations may be omitted, modified, or performed in a different order according to embodiments.

Referring to FIG. 4, in operation 401, an AF 130 may transmit a sensing request message to an NEF 194 to enable a consumer NF (e.g., a consumer NF 193) (e.g., a third party) to use a sensing service.

In an embodiment, the sensing request message may include at least one of the following information elements.
Consumer ID: The identifier of a consumer (e.g., the consumer NF 193) requesting a sensing service may be indicated. For example, the consumer ID may include at least one of an AF ID (e.g., the identifier of the AF when the consumer NF is the AF), an App ID (information for identifying an application provider requesting the sensing service), an external group ID, or a sensing consumer ID.
Requested sensing service type(s): The type(s) of a sensing service requested by the AF 130 may be indicated.
Requested sensing-related parameters per sensing service type
Sensing service-specific parameter: An additional parameter may be included for each sensing service included in the requested sensing service type.

For example, when the sensing service type is object detection, the sensing service-specific parameter may include information about a target object (e.g., a person or a cat).

For example, when the sensing service type is 3D map generation, the sensing service-specific parameter may include frequency information about how often 3D scanning is performed.
Requested sensing time: Time information for requesting activation of a sensing service may be indicated. In an embodiment, the requested sensing time may include the start time and the end time of the sensing service, or the duration (e.g., 30 days) thereof.
Requested sensing service area: Information about an area in which a sensing service is to be used may be indicated. For example, the requested sensing service area may include at least one of a list of a tracking area(s) (TA(s)), a list of a cell(s), or information about a geographical area.
Requested number of sensing nodes: The number of requesting sensing nodes (e.g., UEs or RANs) may be indicated.
Requested sensing accuracy: The required accuracy of a sensing service may be indicated. The requested sensing accuracy may include different information depending on each sensing service.
For example, “requested sensing accuracy” may include precision and/or recall.
Sensing notification triggering information: Information about sensing event notification transmission may be included. In an embodiment, “sensing notification triggering information” may indicate an event-based notification method (e.g., transmitting a sensing notification when a specific event occurs) or a periodic notification method.

In the periodic notification method, the sensing notification triggering information may include a time threshold (i.e., a notification is transmitted every time threshold) and/or a volume threshold (i.e., a notification is transmitted when the amount of sensing data to be included in the notification reaches the volume threshold).
List of UE ID: A UE ID(s) to perform the sensing service may be included. The UE ID may include, for example, at least one of an IP Address/port number, a generic public subscription identifier (GPSI), and/or a medium access control (MAC) address.
List of RAN node ID: A RAN node ID(s) or cell ID(s) to perform the sensing service may be included.
Sensing mode per UE/RAN/cell: A sensing mode for each sensing node (e.g., a UE, a RAN, or a cell) may be included. In an embodiment, each sensing mode may indicate at least one of a sensing signal transmitter, a sensing signal receiver, or both.

In an embodiment, there is a parameter set for a sensing service about which the AF 130 has negotiated in advance with a network (e.g., a 5G network) and the AF 130 stores a sensing reference ID for the negotiated parameter set, the AF 130 may include the sensing reference ID in the sensing request message of operation 401 instead of requested sensing parameters (e.g., at least one of the requested sensing type, the sensing service-specific parameter, the requested sensing area, the requested sensing time, the requested number of sensing nodes, or the requested sensing accuracy).

In operation 402, the NEF 194 may transmit an authorization request message to perform authorization through a UDM 153 in response to the sensing request message. In an embodiment, the authentication request message may include at least one of the following information elements:
Consumer ID: For example, at least one of an AF ID (i.e., the identifier of an AF when the consumer NF is the AF), an App ID (when a specific application provider requests the sensing service), an external group ID, or a sensing consumer ID; or
Some or all of the requested sensing parameters received in operation 401.

In an embodiment, when a UE ID(s) is included in the sensing request message received in operation 401, the NEF 194 may transmit the authorization request message to the UDM 153 to perform authorization through the UDM 153, based on the requested sensing parameters (e.g., at least one of the requested sensing type, the sensing service-specific parameter, the requested sensing area, the requested sensing time, the requested number of sensing nodes, or the requested sensing accuracy) corresponding to the sensing reference ID included for each UE in the sensing request message of operation 401.

The authorization request message may include the AF ID, the UE ID, or some or all of the requested sensing parameters for each UE.

When a plurality of UE IDs is included in the authorization request message, requested sensing parameters for each UE ID may be included in the authorization request message.

In operation 403, the UDM 153 may include an authorization result (e.g., success or failure) in response to the sensing request message of operation 401 in an authorization response message to be transmitted to the NEF 194.

When receiving an authorization request for the requested sensing parameters for each UE in operation 402, the UDM 153 may include an authorization result (e.g., success or failure) with respect to the requested sensing parameters for each UE in an authorization response message to be transmitted to the NEF 194.

In an embodiment, when the authorization result in response to the sensing request included in the authorization response message received from the UDM 153 indicates failure, the NEF 194 may include information indicating that processing the sensing request fails in a sensing response message (not shown) transmitted to the AF 130, and does not perform the remaining operations.

In an embodiment, when the authorization result with respect to the requested sensing parameters for each UE included in the authentication response message received from the UDM 153 indicates failure, the NEF 194 may include information indicating that the sensing request fails for corresponding UEs (i.e., UEs having failed to be authorized) in a sensing response message (not shown) transmitted to the AF 130, and may not perform the remaining operations for the UEs. In an embodiment, the NEF 194 may not include corresponding UE IDs (IDs of the UEs having failed to be authorized in a message (e.g., a sensing request message of operation 404) to be transmitted to an SPF 191, but may include only the UE IDs of UEs successfully authorized.

In operation 404, the NEF 194 may transmit the sensing request message including the information included in the sensing request message of operation 401 to the SPF 191 selected through SPF discovery/selection based on the sensing request message of operation 401. In an embodiment, the NEF 194 may discover and select the SPF 191 through an SPF discovery/selection procedure before operation 404.

In an embodiment, the SPF discovery/selection procedure may include the procedure of FIG. 3. For example, the consumer NF 193 of FIG. 3 may be the NEF 194, and the sensing service type(s) and/or the requested sensing service area in operation 301 may be the sensing service type(s) and/or the requested sensing service area included in the sensing request message received from the NEF 194 in operation 404.

In operation 405, the SPF 191 may transmit a response message (e.g., an ACK) including a sensing request result (e.g., success or failure) to the NEF 194.

The SPF 191 may determine a list of sensing nodes, based on previously stored sensing node information for each sensing service type. Each sensing node in the list of sensing nodes may be one of a RAN node, a cell, or a UE, and may be identified by one of a RAN node ID, a cell ID, or a UE ID.

In operation 406, the SPF 191 may first transmit a transfer request message including at least one of the following information elements to the AMF 150 in order to request activation from the determined sensing node(s).

In an embodiment, when the sensing node is a RAN node or a cell, the transfer request message may include one or more of the following information along with a RAN node ID (or cell ID).
At least one of a sensing mode per sensing node, a sensing service type, a service-specific sensing parameter, a sensing area, sensing time, sensing accuracy, or a sensing notification triggering condition

In an embodiment, when the sensing node is a UE, the transfer request message may include one or more of the following information along with a UE ID.
At least one of a sensing mode per sensing node, a sensing service type, a service-specific sensing parameter, a sensing area, sensing time, sensing accuracy, or a sensing notification triggering condition

When the SPF 191 supports an aggregated response, the SPF 191 may execute a timer configured with a preset timer value when transmitting a first transfer request message (e.g., the transfer request message of operation 406) to the AMF 150 in response to the sensing request in operation 404.

When the RAN node ID (or cell ID) is included in the transfer request message received in operation 406, the AMF 150 may include the information for each RAN node (or cell) received in operation 406 in an N2 message to be transmitted to a corresponding RAN (e.g., a RAN 120) in operation 407.

The RAN 120 may activate a sensing service, based on the information included in the N2 message received from the AMF 150. In an embodiment, the RAN 120 may perform the sensing service, such as object detection and/or map generation, according to an ISAC function, and may generate a sensing result.

In an embodiment, when the RAN 120 supports the sensing service type and the sensing mode, the RAN 120 may activate the sensing service for the sensing service type in the sensing mode.

In an embodiment, the RAN 120 may determine a sensing period, based on information included in the service-specific sensing parameter in the N2 message.

In an embodiment, the RAN 120 may activate the sensing service for the sensing time in the sensing area, based on the sensing area and/or the sensing time included in the N2 message.

In an embodiment, when the N2 message includes the sensing accuracy, the RAN 120 may determine a signal strength for sensing and/or a signal transmission period for sensing in view of the accuracy.

In an embodiment, when the N2 message includes the sensing notification triggering condition, the RAN 120 may determine a transmission period of a sensing notification message (e.g., a sensing notification message transmitted to the AMF 150 or a notification address), based on the condition.

In operation 408, the RAN 120 may include a sensing service activation result in an N2 response message to be transmitted to the AMF 150.

When the UE ID is included in the transfer request message received in operation 406, the AMF 150 may include the information for each UE received in operation 406 in an N1 message to be transmitted to a corresponding UE (e.g., a UE 110) in operation 409.

The UE 110 may activate the sensing service, based on the information included in the N1 message received from the AMF 150. In an embodiment, the UE 110 may perform the sensing service, such as object detection and/or map generation, according to the ISAC function, and may generate a sensing result.

In an embodiment, when the UE 110 is able to support the sensing service type and the sensing mode included in the N1 message, the UE 110 may activate the sensing service for the sensing service type in the sensing mode.

In an embodiment, the UE 110 may determine a sensing period, based on information included in the service-specific sensing parameter in the N1 message.

In an embodiment, when the sensing area and/or the sensing time is included in the N1 message, the UE 110 may activate the sensing service for the sensing time in the sensing area.

In an embodiment, when the N1 message includes the sensing accuracy, the UE 110 may determine a signal strength for sensing and/or a signal transmission period for sensing in view of the accuracy.

In an embodiment, when the N1 message includes the sensing notification triggering condition, the UE 110 may determine a transmission period of a sensing notification message (e.g., a sensing notification message transmitted to the AMF 150 or a notification address), based on the condition.

In operation 410, the UE 110 may include a sensing service activation result in an N1 response message to be transmitted to the AMF 150.

In operation 411, the AMF 150 may transmit a response message including a sensing service activation result (e.g., success or failure) to the SPF 191. In an embodiment, the AMF 150 may include the sensing service activation result for the RAN (or cell) in the response message to be transmitted to the SPF 191, based on the N2 response message for each RAN (or cell) in operation 408. In an embodiment, the AMF 150 may include the sensing service activation result for the corresponding UE in the response message to be transmitted to the SPF 191, based on the N1 response message for each UE in operation 410. In an embodiment, the AMF 150 may transmit the sensing service activation result to the SPF 191 through one or more separate response messages or at least one integrated response message for one or more sensing nodes (e.g., the RAN 120, the UE 110, or the cell).

When the SPF 191 does not support an aggregated response, the SPF 191 may transmit a response message including a sensing activation result for each sensing node to the NEF 194 whenever receiving a response message per sensing node (e.g., the response message in operation 411) in operation 413.

When the SPF 191 supports an aggregated response, the SPF 191 may aggregate sensing service activation results for the sensing nodes in a response message in operation 412. In operation 413, the SPF 191 may transmit the response message (e.g., an aggregated response message) including the aggregated sensing service activation results to the NEF 194.

When the SPF 191 supports an aggregated response, the SPF 191 may transmit an aggregated response message including a sensing activation result per sensing node for the plurality of sensing nodes to the NEF 194 when the timer initiated in operation 406 expires or the response messages of operation 411 are received with respect to all sensing node IDs requested in operation 406. In an embodiment, the aggregated response message may include a transaction ID generated by the SPF 191 in response to the request of the NEF 194 in operation 404.

The aggregated response message may include at least one of the following information elements:
Sensing activation result per UE (e.g., success or failure) for each UE corresponding to the UE ID included in the transfer request message in operation 406;
Sensing activation result per UE/RAN (e.g., success or failure) for each RAN corresponding to the RAN ID included in the transfer request message in operation 406; or
Sensing activation result per UE/cell (e.g., success or failure) for each cell corresponding to the cell ID included in the transfer request message in operation 406.

In operation 414, the NEF 194 may include all or part of the response message received in operation 413 in a sensing response message to be transmitted to the AF 130.

In operation 415, each sensing node (e.g., the RAN 120 or the UE 110) may transmit a sensing notification message (e.g., a sensing event notification message) to the SPF 191. The sensing notification message may be transmitted to the SPF 191 directly from each sensing node, or be transmitted to the SPF 191 through another NF (e.g., the AMF 150). The sensing notification message may include at least one of the following information elements:
Timestamp: Information about time when sensing information is generated;
Sensing node ID: Identifier of the sensing node (e.g., the UE ID, the RAN ID, or the cell ID); or
Sensing information: Information indicating a sensing result. For example, in 3D map generation, sensing information may include information about a 3D space where sensing is performed.

The SPF 191 may aggregate the sensing notification message(s) received in operation 415 if necessary. In operation 416, the SPF 191 may transmit the (aggregated) sensing event notification message to the AF 130 through the NEF 194, based on the sensing notification triggering condition received in operation 401.

The (aggregated) sensing event notification message may include at least one of the following information elements.
Transaction ID and/or sensing information per sensing node (e.g., a timestamp, a sensing node ID, and/or sensing information)

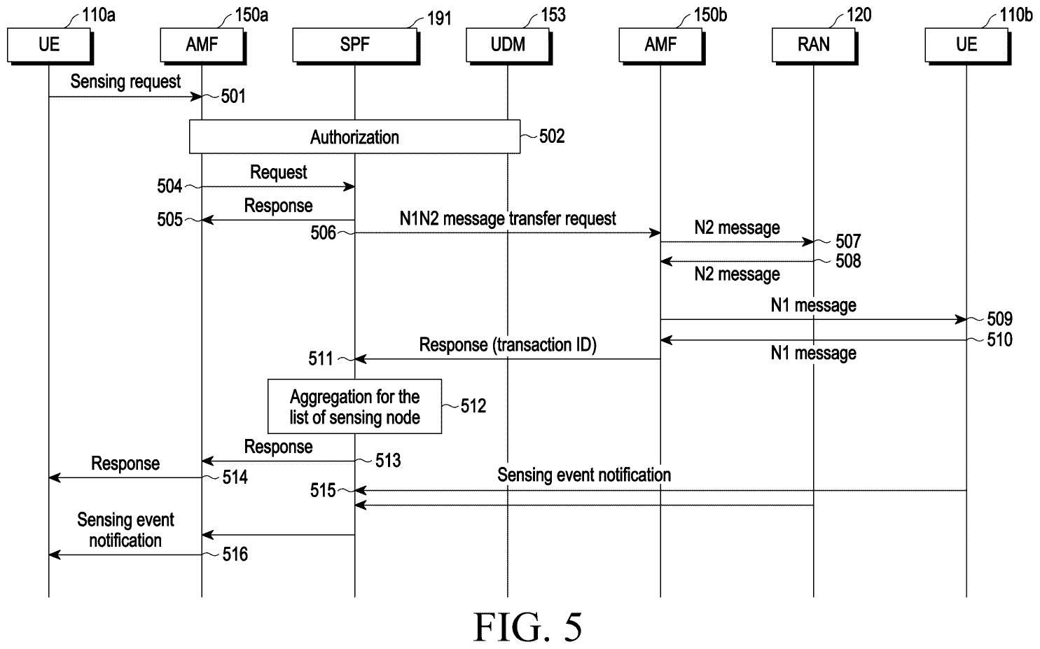

FIG. 5 is a sequence diagram illustrating a procedure in which a UE triggers activation of a sensing service according to an embodiment of the disclosure. At least one of the following operations may be omitted, modified, or performed in a different order according to embodiments.

Referring to FIG. 5, in operation 501, when a specific application (e.g., a third-party application) being executed in a UE (e.g., a UE 110a) requests sensing, the UE 110a may transmit a sensing request message to an AMF 150a in charge of the UE 110 through a RAN 120. The sensing request message may include at least one of the following information elements.
Consumer ID: The identifier of a consumer (e.g., the UE 110 or the application) requesting a sensing service may be included. For example, the consumer ID may include at least one of a UE ID, an App ID (when a specific application provider requests the sensing service), an external group ID, or a sensing consumer ID.
Requested sensing service type(s): The type(s) of a sensing service requested by an AF may be indicated.
Requested sensing-related parameters per sensing service type
Sensing service-specific parameter: An additional parameter(s) may be included for each sensing service included in the requested sensing service type.

For example, when the sensing service type is object detection, the sensing service-specific parameter may include information about a target object (e.g., a person or a cat).

For example, when the sensing service type is 3D map generation, the sensing service-specific parameter may include frequency information about how often 3D scanning is performed.
Requested sensing time: Time information for requesting activation of a sensing service may be indicated. In an embodiment, the requested sensing time may include the start time and the end time of the sensing service, or the duration (e.g., 30 days) thereof.
Requested sensing service area: Information about an area in which a sensing service is to be used may be indicated. For example, the requested sensing service area may include at least one of a list of a TA(s), a list of a cell(s), or information about a geographical area.
Requested number of sensing nodes: The number of requesting sensing nodes (e.g., UEs or RANs) may be indicated.
Requested sensing accuracy: The required accuracy of a sensing service may be indicated. The requested sensing accuracy may include different information depending on each sensing service.

For example, “requested sensing accuracy” may include precision and/or recall.
Sensing notification triggering information: Information about sensing event notification transmission may be included. In an embodiment, “sensing notification triggering information” may indicate an event-based notification method (e.g., transmitting a sensing notification when a specific event occurs) or a periodic notification method.

In an embodiment, the periodic notification method, the sensing notification triggering information may include a time threshold (i.e., a notification is transmitted every time threshold) and/or a volume threshold (i.e., a notification is transmitted when the amount of sensing data to be included in the notification reaches the volume threshold).
List of UE ID: A UE ID(s) to perform the sensing service may be included. The UE ID may include, for example, at least one of an IP Address/port number, a GPSI, and/or a MAC address.
List of RAN node ID: A RAN node ID(s) or cell ID(s) to perform the sensing service may be included.
Sensing mode per UE/RAN/cell: A sensing mode for each sensing node (e.g., a UE, a RAN, or a cell) may be included. In an embodiment, each sensing mode may indicate at least one of a sensing signal transmitter, a sensing signal receiver, or both.

In an embodiment, there is a parameter set for a sensing service about which an application service provider (e.g., an AF 130) has negotiated in advance with a network (e.g., a 5G network) and the UE 110a stores a sensing reference ID for the negotiated parameter set, the UE 110a may include the sensing reference ID in the sensing request message of operation 501 instead of requested sensing parameters (e.g., at least one of the requested sensing type, the sensing service-specific parameter, the requested sensing area, the requested sensing time, the requested number of sensing nodes, or the requested sensing accuracy).

In operation 502, the AMF 150a may transmit an authorization request message to perform authorization through a UDM 153 in response to the sensing request message. In an embodiment, the authentication request message may include at least one of the following information elements:
Consumer ID: For example, at least one of a UE ID, an App ID (when a specific application provider requests a sensing service), an external group ID, or a sensing consumer ID; or
Some or all of the requested sensing parameters received in operation 501.

In an embodiment, when a UE ID(s) is included in the sensing request message received in operation 501, the AMF 150a may transmit the authorization request message to the UDM 153 to perform authorization through the UDM 153, based on the requested sensing parameters (e.g., at least one of the requested sensing type, the sensing service-specific parameter, the requested sensing area, the requested sensing time, the requested number of sensing nodes, or the requested sensing accuracy) corresponding to the sensing reference ID included for each UE in the sensing request message of operation 501.

The authorization request message may include the AF ID, the UE ID, or some or all of the requested sensing parameters for each UE.

When a plurality of UE IDs is included in the authorization request message, requested sensing parameters for each UE ID may be included in the authorization request message.

In operation 503, the UDM 153 may include an authorization result (success or failure) in response to the sensing request message of operation 501 in an authorization response message to be transmitted to the AMF 150a.

When receiving an authorization request for the requested sensing parameters for each UE in operation 502, the UDM 153 may include an authorization result (success or failure) with respect to the requested sensing parameters for each UE in the authorization response message to be transmitted to the AMF 150a.

In an embodiment, when the authorization result in response to the sensing request included in the authorization response message received from the UDM 153 indicates failure, the AMF 150a may include information indicating that processing the sensing request fails in a sensing response message (not shown) transmitted to the UE 110a, and does not perform the remaining operations.

In an embodiment, when the authorization result with respect to the requested sensing parameters for each UE included in the authentication message received from the UDM 153 indicates failure, the AMF 150a may include information indicating that the sensing request fails for a corresponding UE (i.e., UEs having failed to be authorized) in a sensing response message (not shown) transmitted to the UE 110a, and may not perform the remaining operations for the UEs. In an embodiment, the AMF 150a may not include corresponding UE IDs (IDs of the UEs having failed to be authorized) in a message (e.g., a sensing request message of operation 504) to be transmitted to an SPF 191, but may include only the UE IDs of UEs successfully authorized.

In operation 504, the AMF 150a may transmit the sensing request message including the information included in the sensing request message of operation 501 to the SPF 191 selected through SPF discovery/selection based on the sensing request message of operation 501. In an embodiment, the AMF 150a may discover and select the SPF 191 through an SPF discovery/selection procedure before operation 504.

In an embodiment, the SPF discovery/selection procedure may include the procedure of FIG. 3. For example, the consumer NF 193 of FIG. 3 may be the AMF 150a, and the sensing service type(s) and/or the requested sensing service area in operation 301 may be the sensing service type(s) and/or the requested sensing service area included in the sensing request message received from the UE 110a in operation 501.

In operation 505, the SPF 191 may transmit a response message (e.g., an ACK) including a sensing request result (success or failure) to the AMF 150a.

In operation 506, the SPF 191 may determine a list of sensing nodes, based on previously stored sensing node information for each sensing service type.

Each sensing node in the list of sensing nodes may be one of a RAN node, a cell, or a UE, and may be identified by one of a RAN node ID, a cell ID, or a UE ID.

In operation 506, the SPF 191 may first transmit a transfer request message including at least one of the following information elements to an AMF (e.g., an AMF 150b) in charge of a determined sensing node in order to request activation from the determined sensing node(s).

In an embodiment, when the sensing node is a RAN node or a cell, the transfer request message may include one or more of the following information along with a RAN node ID (or cell ID).
At least one of a sensing mode per sensing node, a sensing service type, a service-specific sensing parameter, a sensing area, sensing time, sensing accuracy, or a sensing notification triggering condition

In an embodiment, when the sensing node is a UE (e.g., a UE 110b), the transfer request message may include one or more of the following information along with a UE ID.
At least one of a sensing mode per sensing node, a sensing service type, a service-specific sensing parameter, a sensing area, sensing time, sensing accuracy, or a sensing notification triggering condition

When the SPF 191 supports an aggregated response, the SPF 191 may execute a timer configured with a preset timer value when transmitting a first transfer request message (e.g., the transfer request message of operation 506) to the AMF 150b in response to the sensing request in operation 504.

When the RAN node ID (or cell ID) is included in the transfer request message received in operation 506, the AMF 150b may include the information for each RAN node (or cell) received in operation 506 in an N2 message to be transmitted to a corresponding RAN (e.g., a RAN 120) in operation 507.

The RAN 120 may activate a sensing service, based on the information included in the N2 message received from the AMF 150b. In an embodiment, the RAN 120 may perform the sensing service, such as object detection and/or map generation, according to an ISAC function, and may generate a sensing result.

In an embodiment, when the RAN 120 supports the sensing service type and the sensing mode, the RAN 120 may activate the sensing service for the sensing service type in the sensing mode.

In an embodiment, the RAN 120 may determine a sensing period, based on information included in the service-specific sensing parameter in the N2 message.

In an embodiment, the RAN 120 may activate the sensing service for the sensing time in the sensing area, based on the sensing area and/or the sensing time included in the N2 message.

In an embodiment, when the N2 message includes the sensing accuracy, the RAN 120 may determine a signal strength for sensing and/or a signal transmission period for sensing in view of the accuracy.

In an embodiment, when the N2 message includes the sensing notification triggering condition, the RAN 120 may determine a transmission period of a sensing notification message (e.g., a sensing notification message transmitted to the AMF 150b or a notification address), based on the condition.

In operation 508, the RAN 120 may include a sensing service activation result in an N2 response message to be transmitted to the AMF 150b.

When the UE ID is included in the transfer request message received in operation 506, the AMF 150b may include the information for each UE received in operation 506 in an N1 message to be transmitted to the corresponding UE (e.g., the UE 110b) in operation 509. In an embodiment, the UE 110b may be the same as or different from the UE 110a.

The UE 110b may activate the sensing service, based on the information included in the N1 message received from the AMF 150b. In an embodiment, the UE 110b may perform the sensing service, such as object detection and/or map generation, according to the ISAC function, and may generate a sensing result.

In an embodiment, when the UE 110b is able to support the sensing service type and the sensing mode included in the N1 message, the UE 110 may activate the sensing service for the sensing service type in the sensing mode.

In an embodiment, the UE 110b may determine a sensing period, based on information included in the service-specific sensing parameter in the N1 message.

In an embodiment, when the sensing area and/or the sensing time is included in the N1 message, the UE 110b may activate the sensing service for the sensing time in the sensing area.

In an embodiment, when the N1 message includes the sensing accuracy, the UE 110b may determine a signal strength for sensing and/or a signal transmission period for sensing in view of the accuracy.

In an embodiment, when the N1 message includes the sensing notification triggering condition, the UE 110b may determine a transmission period of a sensing notification message (e.g., a sensing notification message transmitted to the AMF 150b or a notification address), based on the condition.

In operation 510, the UE 110b may include a sensing service activation result in an N1 response message to be transmitted to the AMF 150b.

In operation 511, the AMF 150b may transmit a response message including a sensing service activation result (e.g., success or failure) to the SPF 191. In an embodiment, the AMF 150b may include the sensing service activation result for the RAN (or cell) in the response message to be transmitted to the SPF 191, based on the N2 response message for each RAN (or cell) in operation 508. In an embodiment, the AMF 150b may include the sensing service activation result for the corresponding UE (e.g., the UE 110b) in the response message to be transmitted to the SPF 191, based on the N1 response message for each UE in operation 510. In an embodiment, the AMF 150b may transmit the sensing service activation result to the SPF 191 through one or more response messages for one or more sensing nodes (e.g., the RAN 120, the UE 110b, or the cell).

When the SPF 191 does not support an aggregated response, the SPF 191 may transmit a response message including a sensing activation result for each sensing node to the AMF 150a whenever receiving a response message per sensing node (e.g., the response message of operation 511) in operation 513.

When the SPF 191 supports an aggregated response, the SPF 191 may aggregate sensing service activation request results for the sensing nodes in a response message in operation 512. In operation 513, the SPF 191 may transmit the response message (e.g., an aggregated response message) including the aggregated sensing service activation results to the AMF 150a.

When the SPF 191 supports an aggregated response, the SPF 191 may transmit an aggregated response message including a sensing activation result per sensing node for all sensing nodes to the AMF 150a when the timer initiated in operation 506 expires or the response messages of operation 511 are received with respect to all sensing node IDs requested in operation 506. In an embodiment, the aggregated response message may include a transaction ID generated by the SPF 191 in response to the request of the AMF 150a in operation 504.

The aggregated response message may include at least one of the following information elements:
Sensing activation result per UE (e.g., success or failure) for each UE (e.g., the UE 110b) corresponding to the UE ID included in the transfer request message in operation 506;
Sensing activation result per UE/RAN (e.g., success or failure) for each RAN (e.g., the RAN 120) corresponding to the RAN ID included in the transfer request message in operation 506; or
Sensing activation result per UE/cell (e.g., success or failure) for each cell corresponding to the cell ID included in the transfer request message in operation 506.

In operation 514, the AMF 150a may include all or part of the response message received in operation 513 in a sensing response message to be transmitted to the UE 110a.

In operation 515, each sensing node (e.g., the RAN 120 or the UE 110b) may transmit a sensing notification message to the SPF 191. The sensing notification message may be transmitted to the SPF 191 directly from each sensing node, or be transmitted to the SPF 191 through another NF (e.g., the AMF 150b). The sensing notification message may include at least one of the following information elements:
Timestamp: Information about time when sensing information is generated;
Sensing node ID: Identifier of the sensing node (e.g., the UE ID, the RAN ID, or the cell ID); or
Sensing information: Information indicating a sensing result. For example, in 3D map generation, sensing information may include information about a 3D space where sensing is performed.

The SPF 191 may aggregate the sensing notification message(s) received in operation 515 if necessary. In operation 516, the SPF 191 may transmit the (aggregated) sensing event notification message to the UE 110a through the AMF 150a, based on the sensing notification triggering condition received in operation 501.

The (aggregated) sensing notification message may include at least one of the following information elements.
Transaction ID and/or sensing information per sensing node (e.g., a timestamp, a sensing node ID, and/or sensing information)

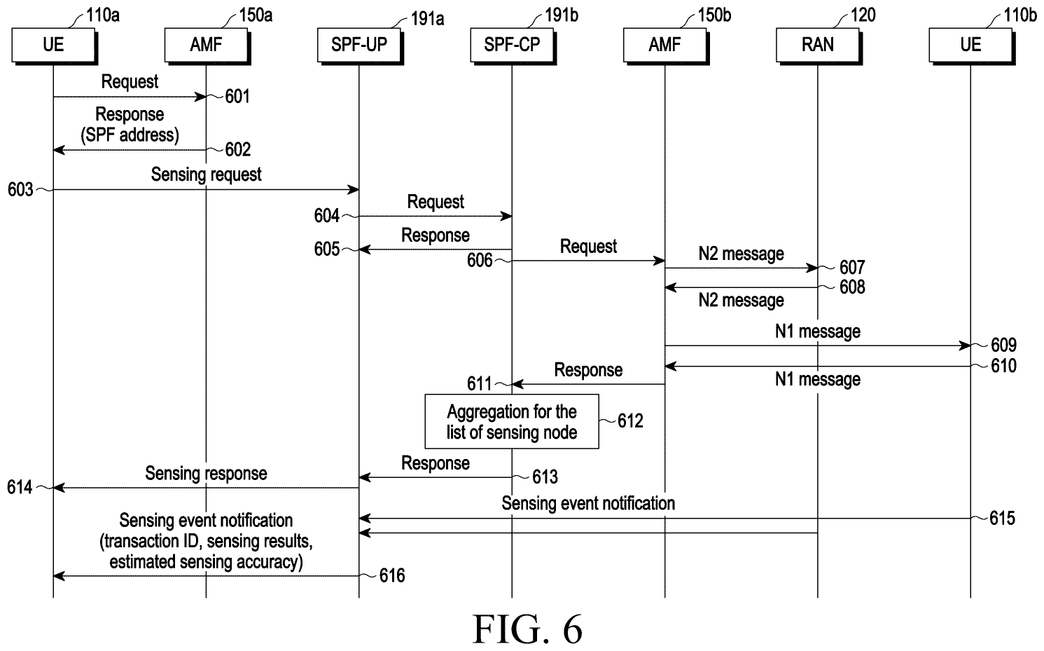

FIG. 6 is a sequence diagram illustrating a procedure in which a UE triggers activation of a sensing service through a user plane according to an embodiment of the disclosure. At least one of the following operations may be omitted, modified, or performed in a different order according to embodiments.

Referring to FIG. 6, in operation 601, a UE (e.g., a UE 110a) may transmit a request message including information indicating that a sensing service is available to an AMF (e.g., an AMF 150a).

In operation 602, the AMF 150a may transmit, to the UE 110a, a response message including at least one of an SPF address, a supported sensing service type for a corresponding SPF, or a sensing area. In an embodiment, the SPF address may indicate the user-plane address (e.g., an FQDN and/or IP address/port number) of an NF (e.g., an SPF-UP 191a) that manages a sensing service. In an embodiment, the SPF address may include an address accessible via the Internet (e.g., a DN 171). In an embodiment, the SPF-UP 191a may be collocated with an NEF 194, a PCF 180, or an NWDAF. In an embodiment, the AMF 150a may discover and select the SPF-UP 191a through an SPF discovery/selection procedure before operation 602.

In operation 603, when a specific application (e.g., a third-party application) being executed in the UE 110a requests sensing and the UE 110a has previously stored SPF information (e.g., the SPF-UP address, the sensing service type, and/or the sensing area provided in operation 602), the UE 110a may select the SPF (e.g., the SPF-UP 191a) to which a sensing request is to be transmitted, based on the SPF information, and may transmit a sensing request message to the SPF-UP 191a by using the SPF-UP address.

In an embodiment, the sensing request message may be transmitted through a packet data unit (PDU) session. When the UE 110a has no PDU session, the UE 110a may perform a PDU session establishment procedure (not shown) to transmit the sensing request message.

In an embodiment, the sensing request message may include at least one of the following information elements.
Consumer ID: The identifier of a consumer (e.g., the UE 110 or the application) requesting a sensing service may be included. For example, the consumer ID may include at least one of a UE ID, an App ID (when a specific application provider requests the sensing service), an external group ID, or a sensing consumer ID.
Requested sensing service type(s): The type(s) of a sensing service requested by an AF may be indicated.
Requested sensing-related parameters per sensing service type.
Sensing service-specific parameter: An additional parameter(s) may be included for each sensing service included in the requested sensing service type.

For example, when the sensing service type is object detection, the sensing service-specific parameter may include information about a target object (e.g., a person or a cat).

For example, when the sensing service type is 3D map generation, the sensing service-specific parameter may include frequency information about how often 3D scanning is performed.
Requested sensing time: Time information for requesting activation of a sensing service may be indicated. In an embodiment, the requested sensing time may include the start time and the end time of the sensing service, or the duration (e.g., 30 days) thereof.
Requested sensing service area: Information about an area in which a sensing service is to be used may be indicated. For example, the requested sensing service area may include at least one of a list of a TA(s), a list of a cell(s), or information about a geographical area.
Requested number of sensing nodes: The number of requesting sensing nodes (e.g., UEs or RANs) may be indicated.
Requested sensing accuracy: The required accuracy of a sensing service may be indicated. The requested sensing accuracy may include different information depending on each sensing service.

For example, “requested sensing accuracy” may include precision and/or recall.
Sensing notification triggering information: Information about sensing event notification transmission may be included. In an embodiment, “sensing notification triggering information” may indicate an event-based notification method (e.g., transmitting a sensing notification when a specific event occurs) or a periodic notification method.

In an embodiment, the periodic notification method, the sensing notification triggering information may include a time threshold (i.e., a notification is transmitted every time threshold) and/or a volume threshold (i.e., a notification is transmitted when the amount of sensing data to be included in the notification reaches the volume threshold).
List of UE ID: A UE ID(s) to perform the sensing service may be included. The UE ID may include, for example, at least one of an IP Address/port number, a GPSI, and/or a MAC address.
List of RAN node ID: A RAN node ID(s) or cell ID(s) to perform the sensing service may be included.
Sensing mode per UE/RAN/cell: A sensing mode for each sensing node (e.g., a UE, a RAN, or a cell) may be included. In an embodiment, each sensing mode may indicate at least one of a sensing signal transmitter, a sensing signal receiver, or both.

In an embodiment, there is a parameter set for a sensing service about which an application service provider has negotiated in advance with a network and the UE 110a stores a sensing reference ID for the negotiated parameter set, the UE 110a may include the sensing reference ID in the sensing request message of operation 601 instead of requested sensing parameters (e.g., at least one of the requested sensing type, the sensing service-specific parameter, the requested sensing area, the requested sensing time, the requested number of sensing nodes, or the requested sensing accuracy).

In operation 604, the SPF-UP 191a may transmit the sensing request message to an entity (e.g., an SPF-control plane (CP) 191b) that provides an interface between a 5G core network and the SPF-UP 191a.

In operation 605, the SPF-CP 191b may transmit a response message (e.g., an ACK) to the SPF-UP 191a in response to the sensing request message.

The SPF-CP 191b may determine a list of sensing nodes, based on previously stored sensing node information for each sensing service type.

Each sensing node in the list of sensing nodes may be one of a RAN node, a cell, or a UE, and may be identified by one of a RAN node ID, a cell ID, or a UE ID.

In operation 606, the SPF-CP 191b may transmit a request message (e.g., a transfer request message) including at least one of the following information elements to an AMF (e.g., an AMF 150b) in charge of a determined sensing node in order to request activation from the determined sensing node(s).

In an embodiment, when the sensing node is a RAN node or a cell, the request message may include one or more of the following information along with a RAN node ID (or cell ID).
At least one of a sensing mode per sensing node, a sensing service type, a service-specific sensing parameter, a sensing area, sensing time, sensing accuracy, or a sensing notification triggering condition

In an embodiment, when the sensing node is a UE, the request message may include one or more of the following information along with a UE ID.
At least one of a sensing mode per sensing node, a sensing service type, a service-specific sensing parameter, a sensing area, sensing time, sensing accuracy, or a sensing notification triggering condition

When the SPF-CP 191b supports an aggregated response, the SPF-CP 191b may execute a timer configured with a preset timer value when transmitting a first request message (e.g., the request message of operation 606) to the AMF 150b in response to the request in operation 604.

When the RAN node ID (or cell ID) is included in the request message received in operation 606, the AMF 150b may include the information for each RAN node (or cell) received in operation 606 in an N2 message to be transmitted to a corresponding RAN (e.g., a RAN 120) in operation 607.

The RAN 120 may activate a sensing service, based on the information included in the N2 message received from the AMF 150b.

In an embodiment, when the RAN 120 supports the sensing service type and the sensing mode, the RAN 120 may activate the sensing service for the sensing service type in the sensing mode. In an embodiment, the RAN 120 may perform the sensing service, such as object detection and/or map generation, according to an ISAC function, and may generate a sensing result.

In an embodiment, the RAN 120 may determine a sensing period, based on information included in the service-specific sensing parameter in the N2 message.

In an embodiment, the RAN 120 may activate the sensing service for the sensing time in the sensing area, based on the sensing area and/or the sensing time included in the N2 message.

In an embodiment, when the N2 message includes the sensing accuracy, the RAN 120 may determine a signal strength for sensing and/or a signal transmission period for sensing in view of the accuracy.

In an embodiment, when the N2 message includes the sensing notification triggering condition, the RAN 120 may determine a transmission period of a sensing notification message (e.g., a sensing notification message transmitted to the AMF 150b or a notification address), based on the condition.

In operation 608, the RAN 120 may include a sensing service activation result in an N2 response message to be transmitted to the AMF 150b.

When the UE ID is included in the request message received in operation 606, the AMF 150b may include the information for each UE received in operation 606 in an N1 message to be transmitted to the corresponding UE (e.g., the UE 110b) in operation 609.

The UE 110b may activate the sensing service, based on the information included in the N1 message received from the AMF 150b. In an embodiment, the UE 110b may perform the sensing service, such as object detection and/or map generation, according to the ISAC function, and may generate a sensing result.

In an embodiment, when the UE 110b is able to support the sensing service type and the sensing mode included in the N1 message, the UE 110b may activate the sensing service for the sensing service type in the sensing mode.

In an embodiment, the UE 110b may determine a sensing period, based on information included in the service-specific sensing parameter in the N1 message.

In an embodiment, when the sensing area and/or the sensing time is included in the N1 message, the UE 110b may activate the sensing service for the sensing time in the sensing area.

In an embodiment, when the N1 message includes the sensing accuracy, the UE 110b may determine a signal strength for sensing and/or a signal transmission period for sensing in view of the accuracy.

In an embodiment, when the N1 message includes the sensing notification triggering condition, the UE 110b may determine a transmission period of a sensing notification message (e.g., a sensing notification message transmitted to the AMF 150b or a notification address), based on the condition.

In operation 610, the UE 110b may include a sensing service activation result in an N1 response message to be transmitted to the AMF 150b.

In operation 611, the AMF 150b may transmit a response message including a sensing service activation result (e.g., success or failure) to the SPF-CP 191b. In an embodiment, the AMF 150b may include the sensing service activation result for the RAN (or cell) in the response message to be transmitted to the SPF-CP 191b, based on the N2 response message for each RAN (or cell) in operation 608. In an embodiment, the AMF 150b may include the sensing service activation result for the corresponding UE in the response message to be transmitted to the SPF-CP 191b, based on the N1 response message for each UE in operation 610. In an embodiment, the AMF 150b may transmit the sensing service activation result to the SPF-CP 191b through one or more separate response messages or at least one integrated response message for one or more sensing nodes (e.g., the RAN 120, the UE 110b, or the cell).

When the SPF-CP 191b does not support an aggregated response, the SPF-CP 191b may transmit a response message including a sensing activation result for each sensing node to the SPF-UP 191a whenever receiving a response message per sensing node (e.g., the response message of operation 611) in operation 613.

When the SPF-CP 191b supports an aggregated response, the SPF-CP 191b may aggregate sensing service activation request results for the sensing nodes in a response message in operation 612. In operation 613, the SPF-CP 191b may transmit the response message (e.g., an aggregated response message) including the aggregated sensing service activation results to the SPF-UP 191a.

When the SPF-CP 191b supports an aggregated response, the SPF-CP 191b may transmit an aggregated response message including a sensing activation result per sensing node for all sensing nodes to the SPF-UP 191a when the timer initiated in operation 606 expires or the response messages of operation 611 are received with respect to all sensing node IDs requested in operation 606. In an embodiment, the aggregated response message may include a transaction ID generated by the SPF-CP 191b in response to the request of the SPF-UP 191a in operation 604.

The aggregated response message may include at least one of the following information elements:
Sensing activation result per UE (e.g., success or failure) for each UE corresponding to the UE ID included in the request message in operation 606;
Sensing activation result per UE/RAN (e.g., success or failure) for each RAN corresponding to the RAN ID included in the request message in operation 606; or
Sensing activation result per UE/cell (e.g., success or failure) for each cell corresponding to the cell ID included in the request message in operation 606.

In operation 614, the SPF-UP 191a may include all or part of the response message received in operation 613 in a sensing response message to be transmitted to the UE 110a.

In operation 615, each sensing node (e.g., the RAN 120 or the UE 110b) may transmit a sensing notification message to the SPF-UP 191a. The sensing notification message may be transmitted to the SPF-UP 191a directly from each sensing node, or be transmitted to the SPF-UP 191a through another NF (e.g., the AMF 150b). The sensing notification message may include at least one of the following information elements.
Timestamp: Information about time when sensing information is generated
Sensing node ID: Identifier of the sensing node (e.g., the UE ID, the RAN ID, or the cell ID)
Sensing information: Information indicating a sensing result. For example, in 3D map generation, sensing information may include information about a 3D space where sensing is performed.

The SPF-UP 191a may aggregate the sensing notification message(s) received in operation 615 if necessary. In operation 616, the SPF-UP 191a may transmit the (aggregated) sensing event notification message to the UE 110a through the AMF 150a, based on the sensing notification triggering condition received in operation 601.

The (aggregated) sensing message may include the following information.
Transaction ID and/or sensing information per sensing node (e.g., a timestamp, a sensing node ID, and/or sensing information)

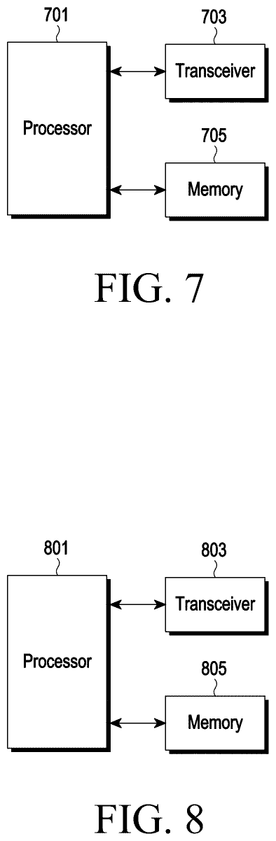

FIG. 7 is a block diagram illustrating the configuration of a UE according to an embodiment of the disclosure.

Referring to FIG. 7, the UE (e.g., a UE 110, a UE 110a, or a UE 110b) may include at least one of a processor 701, a transceiver 703, or memory 705. The UE is not limited to a form including only the illustrated components, and may include more components or fewer components than the illustrated components.

According to an embodiment of the disclosure, the transceiver 703 may transmit and receive a signal to and from at least one network entity (e.g., an RAN 120, an AMF 150, or an SPF-UP 191a) and/or at least one another UE. The signal transmitted and received between the network entity and the UE may include at least one of control information or data. The transceiver 703 may receive a signal through a radio channel to transmit the signal to the processor 701, and may transmit a signal received from the processor 701 through the radio channel.

According to an embodiment of the disclosure, the processor 701 may control the operation of the UE to perform an operation corresponding to at least one of the embodiments of FIGS. 4 to 6.

At least one of the processor 701, the transceiver 703, or the memory 705 are not necessarily configured as separate modules, but may be configured as a single component in the form of a single chip. The processor 701 and the transceiver 703 may be electrically connected. The processor 701 may include an application processor (AP) and/or a communication processor (CP).

According to an embodiment of the disclosure, the memory 705 may store data, such as a basic programs, an application program, and configuration information, for the operation of the UE. The memory 705 may provide the stored data upon request from the processor 701. The memory 705 may be configured as a storage medium, such as read-only memory (ROM), random-access memory (RAM), a hard disk, compact disc read-only memory (CD-ROM), and a digital versatile disc (DVD), or a combination of storage media. The memory 705 may include a plurality of memories. The processor 701 may perform at least one of the operations corresponding to the embodiments of the disclosure, based on a program for performing the at least one of the operations corresponding to the embodiments of the disclosure stored in the memory 705.

FIG. 8 is a block diagram illustrating the configuration of a network entity according to an embodiment of the disclosure.

Referring to FIG. 8, the network entity (e.g., at least one of an SPF 191, an SPF-UP 191a, an SPF-CP 191b, a RAN 120, an AMF 150, an NRF 192, a consumer NF 193, an NRF 192, or an NEF 194) may include at least one of a processor 801, a transceiver 803 including a transmitter and/or a receiver, or memory 805. The network entity is not limited to a form including only the illustrated components, and may include more components or fewer components than the illustrated components.

According to an embodiment of the disclosure, the transceiver 803 may transmit and receive a signal to and from at least one another network entity (e.g., at least one of the SPF 191, the SPF-UP 191a, the SPF-CP 191b, the RAN 120, the AMF 150, the NRF 192, the consumer NF 193, the NRF 192, or the NEF 194) and/or at least one UE (e.g., a UE 110). The signal transmitted and received between the at least one other network entity and/or the at least one UE may include at least one of control information or data. When the network entity illustrated in FIG. 8 is a base station (e.g., the RAN 120), the transceiver 803 may include a transceiver configured to transmit and receive a radio signal to and from the UE (e.g., the UE 110) and a transceiver or communication interface configured to transmit and receive a signal to and from another network entity of a core network.

According to an embodiment of the disclosure, the processor 801 may control the network entity to perform at least one of operations corresponding to the embodiments of FIGS. 2 to 6. The processor 801, the transceiver 803, and the memory 805 are not necessarily configured as separate modules, but may be configured as a single component in the form of a single chip. The processor 801 and the transceiver 803 may be electrically connected. The processor 801 may include an AP and/or a CP.

According to an embodiment of the disclosure, the memory 805 may store data, such as a basic programs, an application program, and configuration information, for the operation of the network entity. The memory 805 may provide the stored data upon request from the processor 801. The memory 805 may be configured as a storage medium, such as ROM, RAM, a hard disk, CD-ROM, and a DVD, or a combination of storage media. The memory 805 may include a plurality of memories. The processor 801 may perform at least one of the operations corresponding to the embodiments of the disclosure, based on a program for performing the at least one of the operations corresponding to the embodiments of the disclosure stored in the memory 805.

A UE (e.g., the UE 110) according to an embodiment of the disclosure may be one of various types of devices. The UE may include, for example, a portable communication device (e.g., a smart phone), a computer device, a portable multimedia device, a portable medical device, a camera, a wearable device, or a home appliance. The UE according to an embodiment of the disclosure is not limited to those described above.

It should be appreciated that an embodiment of the disclosure and the terms used therein are not intended to limit the technical features set forth herein to particular embodiments and the disclosure includes various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in an embodiment of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

An embodiment of the disclosure may be implemented as software (e.g., program) including one or more instructions stored in a storage medium that is readable by a machine (e.g., UE). For example, a processor of the machine (e.g., UE) may invoke at least one of the one or more instructions stored in the storage medium, and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each element (e.g., a module or a program) of the above-described elements may include a single entity or multiple entities, and some of the multiple entities may also be separately disposed in another element. According to an embodiment, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

Also, the above respective embodiments may be employed in combination, as necessary. For example, the methods proposed in the disclosure may be partially combined with each other to operate a network entity and a UE. Moreover, although the embodiments of the disclosure have been described based on the 5G or NR system, other variants based on the technical idea of the embodiments may also be implemented in other communication systems such as LTE, LTE-A, or LTE-A-Pro systems.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for providing an integrated sensing service by a network entity in a wireless communication system, the method comprising:
receiving, from a first device, a request message for requesting a sensing service related to at least one sensing node;
transmitting, to an access and mobility management function (AMF) related to the at least one sensing node, a transfer request message for requesting sensing service activation based on the request message; and
receiving, from the at least one sensing node, at least one sensing event notification message comprising a sensing result based on the request message.

2. The method of claim 1, wherein the request message comprises at least one of a consumer ID, a requested sensing service type, requested sensing-related parameters per sensing service type, parameters per sensing service, requested sensing time, a requested sensing service area, a requested number of sensing nodes, requested sensing accuracy, sensing notification triggering information, a list of sensing nodes, or a sensing mode per sensing node.

3. The method of claim 1, further comprising:
receiving, from the AMF, at least one sensing response message indicating a sensing service activation result for the at least one sensing node; and
transmitting, to the first device, a sensing response message comprising the sensing service activation result for the at least one sensing node.

4. The method of claim 3, further comprising:
aggregating one or more sensing response messages received from the AMF into one aggregated response message; and
transmitting, to the first device, the aggregated response message.

5. The method of claim 1, wherein the transfer request message comprises at least one of a radio access network (RAN) node ID, a cell ID, a sensing mode per sensing node, a sensing service type, a sensing parameter per service, a sensing area, sensing time, sensing accuracy, or a sensing notification triggering condition, with respect to a first sensing node corresponding to a RAN or a cell.

6. The method of claim 1, wherein the transfer request message comprises at least one of a sensing mode per sensing node, a sensing service type, a sensing parameter per service, a sensing area, sensing time, sensing accuracy, or a sensing notification triggering condition, with respect to a second sensing node corresponding to a user equipment (UE).

7. The method of claim 1, wherein the first device comprises at least one of a network exposure function (NEF), a first AMF, or a user equipment (UE).

8. The method of claim 1, further comprising:
transmitting, to the first device, a sensing event notification message comprising the at least one sensing notification message,
wherein the at least one sensing notification message comprises at least one of a timestamp, a sensing node ID, or sensing information.

9. The method of claim 1,
wherein the sensing event notification message comprises at least one of a transaction ID or sensing information per sensing node, and
wherein the sensing information per sensing node comprises at least one of a timestamp, a sensing node ID, or sensing information.

10. The method of claim 1, wherein the network entity comprises a sensing provider function (SPF).

11. A network entity for providing an integrated sensing service in a wireless communication system, the network entity comprising:
a transceiver; and
a processor operatively coupled to the transceiver,
wherein the processor is configured to:
receive, from a first device, a request message for requesting a sensing service related to at least one sensing node,
transmit, to an access and mobility management function (AMF) related to the at least one sensing node, a transfer request message for requesting sensing service activation based on the request message, and
receive, from the at least one sensing node, at least one sensing notification message comprising a sensing result based on the request message.

12. The network entity of claim 11, wherein the request message comprises at least one of a consumer ID, a requested sensing service type, requested sensing-related parameters per sensing service type, parameters per sensing service, requested sensing time, a requested sensing service area, a requested number of sensing nodes, requested sensing accuracy, sensing notification triggering information, a list of sensing nodes, or a sensing mode per sensing node.

13. The network entity of claim 11, wherein the processor is further configured to:
receive, from the AMF, at least one sensing response message indicating a sensing service activation result for the at least one sensing node; and
transmit, to the first device, a sensing response message comprising the sensing service activation result for the at least one sensing node.

14. The network entity of claim 13, wherein the processor is further configured to:
aggregate one or more sensing response messages received from the AMF into one aggregated response message; and
transmit, to the first device, the aggregated response message.

15. The network entity of claim 11, wherein the transfer request message comprises at least one of a radio access network (RAN) node ID, a cell ID, a sensing mode per sensing node, a sensing service type, a sensing parameter per service, a sensing area, sensing time, sensing accuracy, or a sensing notification triggering condition, with respect to a first sensing node corresponding to a RAN or a cell.

16. The network entity of claim 11, wherein the transfer request message comprises at least one of a sensing mode per sensing node, a sensing service type, a sensing parameter per service, a sensing area, sensing time, sensing accuracy, or a sensing notification triggering condition, with respect to a second sensing node corresponding to a user equipment (UE).

17. The network entity of claim 11, wherein the first device comprises at least one of a network exposure function (NEF), a first AMF, or a user equipment (UE).

18. The network entity of claim 11,
wherein the processor is further configured to transmit, to the first device, a sensing event notification message comprising the at least one sensing notification message,
wherein the at least one sensing notification message comprises at least one of a timestamp, a sensing node ID, or sensing information.

19. The network entity of claim 18,
wherein the sensing event notification message comprises at least one of a transaction ID or sensing information per sensing node, and
wherein the sensing information per sensing node comprises at least one of the timestamp, the sensing node ID, or the sensing information.

20. The network entity of claim 19, wherein the network entity comprises a sensing provider function (SPF).
